(19) United States
(12) Patent Application Publication
(10) Pub. No.: US 2026/0341876 A1
(43) Pub. Date: Oct. 29, 2026

(54) TRACK ASSEMBLY MOUNTED BATTERY PACK

(71) Applicant: Deere & Company, Moline, IL (US)

(72) Inventor: Nilesh T. Kumbhar, Karad (IN)

(21) Appl. No.: 19/188,093

(22) Filed: Apr. 24, 2025

(51) Int. Cl. H01M 50/244; B60K 1/04

(52) U.S. Cl. CPC H01M 50/244; B60K 1/04; B60K 2001/0405; H01M 2220/20

(57) ABSTRACT

A vehicle including a main frame, a battery pack, and a track assembly disposed on each lateral side of the main frame. Each track assembly includes a track frame, a plurality of track wheels, and a track loop extending around the plurality of track wheels. The battery pack is mounted to the track frame.

### FIELD OF THE DISCLOSURE

The present disclosure relates to battery electric and hybrid construction equipment and more particularly to a compact track loader with a track assembly mounted battery pack.

### BACKGROUND

Efforts are underway in the industry to replace traditional diesel-powered construction machinery with electric-powered alternatives, such as battery, hybrid, and plug-in hybrid technologies in order to operate machinery like excavators, loaders, and compactors. Operating this equipment with electric power can reduce emissions, noise pollution, and improve working conditions on construction sites while offering potential cost savings through lower maintenance needs. However, compact machinery including compact track loaders (CTLs), for example, can prove challenging to redesign and convert to electrical power due to the limited space for electrical components, especially batteries.

### SUMMARY

In one implementation of the present disclosure, a vehicle includes a main frame, a battery pack, and a track assembly disposed on each lateral side of the main frame. Each track assembly includes a track frame, a plurality of track wheels, and a track loop extending around the plurality of track wheels. The battery pack is mounted to the track frame.

In one example of this implementation, the vehicle includes four track wheels supporting the track loop in a quadrilateral configuration. In a second example, three of the four track wheels are idler track wheels carried by the track frame and one of the four track wheels is a drive wheel. In a third example of this implementation, the quadrilateral configuration is a trapezoidal configuration. In a fourth example, the battery pack is positioned on a top side of the track frame. In a fifth example of this implementation, the vehicle includes a battery pack mounted to the main frame. In a sixth example, the battery pack is in electrical communication with a drive motor of the vehicle. In a seventh example, the battery pack is removable from the track assembly while the track assembly is attached to the main frame. In an eighth example of this implementation, the track frame includes a longitudinal member supporting an idler track wheel at a forward end portion and an idler track wheel at a rearward end portion. In a nineth example, the battery pack is positioned on a top side of the track frame between the forward end portion and the rearward end portion. In a tenth example, the vehicle includes three track wheels supporting the track loop in a triangular configuration. In an eleventh example of this implementation, a pair of idler track wheels are supported at the forward end portion.

In another implementation of the present disclosure, a track assembly for a vehicle includes a battery pack, a track frame mountable on the vehicle, at least one idler track wheel, and a track loop. The track loop extends around the at least one track wheel and is engageable with a drive wheel of the vehicle. The battery pack is mounted to the track frame.

In one example of this implementation, the track assembly includes three idler track wheels positioned on the track frame to support the track loop, in conjunction with the drive wheel, in a quadrilateral configuration. In a second example, the quadrilateral configuration is a trapezoidal configuration. In a third example of this implementation, the battery pack is positioned on a top side of the track frame. In a fourth example, the battery pack is electrically connectable to a drive motor of the vehicle. In a fifth example of this implementation, the battery pack is removable from the track assembly while the track assembly is attached to the vehicle. In a sixth example of this implementation, the track frame includes a longitudinal member supporting an idler track wheel at a forward end portion and an idler track wheel at a rearward end portion. In a seventh of this implementation example, a pair of idler track wheels are supported at the forward end portion.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a perspective view of a compact track loader.

FIG. 2A is a perspective view illustrating one implementation of a track assembly.

FIG. 2B is a perspective view of the track assembly shown in FIG. 2A as viewed from the opposite side.

FIG. 3 is a side view of the track assembly shown in FIGS. 1-2B.

FIG. 4 is a partially exploded perspective view of the track assembly shown in FIGS. 1-3.

Corresponding reference numerals are used to indicate corresponding parts throughout the several views.

### DETAILED DESCRIPTION

Before any implementations of the disclosure are explained in detail, it is to be understood that the disclosure is not limited in its application to the details of construction and the arrangement of components set forth in the following description or illustrated in the accompanying drawings. The disclosure is capable of supporting other implementations and of being practiced or of being carried out in various ways. Also, it is to be understood that the phraseology and terminology used herein is for the purpose of description and should not be regarded as limiting.

As research and development continues in battery electric and hybrid technologies to replace traditional diesel-powered construction machinery with electric-powered alternatives, many in the industry are attempting to find efficient ways to integrate electric drive components into conventional machine platforms. One of the main challenges for this integration is the ability to maintain commonality with current production vehicles by following existing assembly and fabrication tooling requirements. For compact equipment, this challenge is exacerbated due to the limited availability of packaging space. Another unique challenge for hybrid/BEV vehicles is constrained service access to the battery pack(s) which can result in increased downtime in case of any necessary replacement or service. In some attempts, the battery pack is mounted within a main frame of the vehicle (e.g., a CTL), which can be difficult to access and require that much, if not all, of the vehicle’s undercarriage be removed to access the batteries.

The disclosed technology is directed to a unique configuration for the CTL track assemblies (also referred to herein as undercarriage/tracks) which provides for integration of the battery packs within the track assemblies. Having battery packs outside the main vehicle frame can help to maintain architectural commonality between conventional and electric vehicles, improve service access to the battery packs, and further enhance safety.

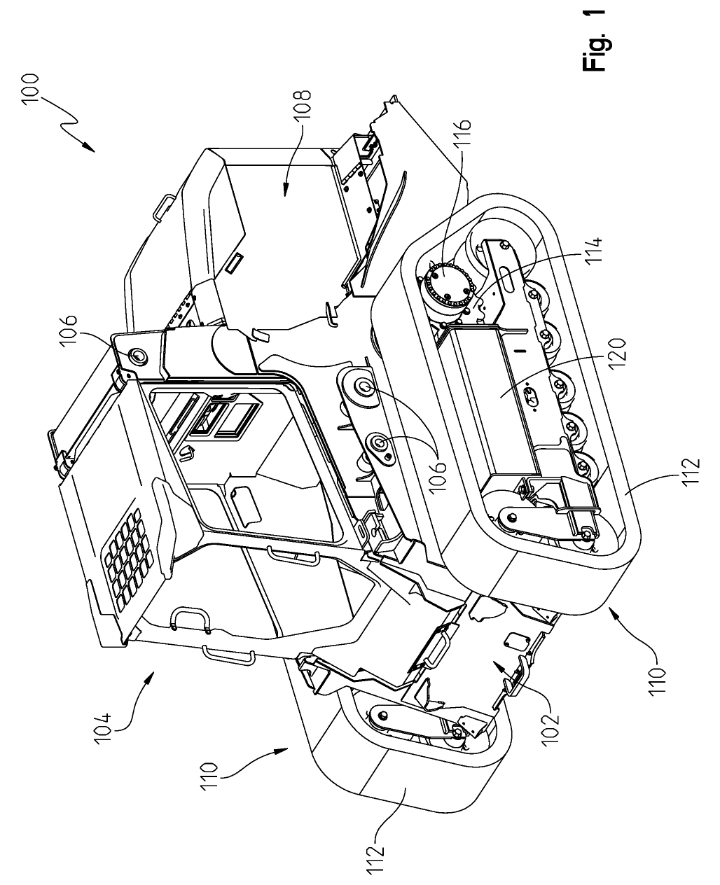

FIG. 1 illustrates a tracked vehicle, such as a compact track loader (CTL) 100. In some implementations, the CTL 100 includes a main frame 102 supporting an operator's cab 104 that is mounted on the frame 102 adjacent a prime mover 108, such as an engine. The main frame 102 also includes pivot points 106 for attaching boom arms (not shown) that can carry various attachments, including buckets, blades, rotary cutters, root rakes, mulching heads, and augers, to name just a few.

The main frame 102 is carried by a pair of track assemblies 110 disposed on each lateral side of the main frame 102 as shown. The track assemblies 110 can also be referred to as undercarriage assemblies. In some implementations, each track assembly 110 includes a rubber track loop 112 that is driven by a hydraulic or electric motor 116 via a track wheel i.e., drive wheel or sprocket 114. As explained further herein, each track assembly 110 is configured to carry a battery pack 120. The battery packs 120 can be used in hybrid, plug-in hybrid, battery electric, or other propulsion configurations that use a battery or batteries.

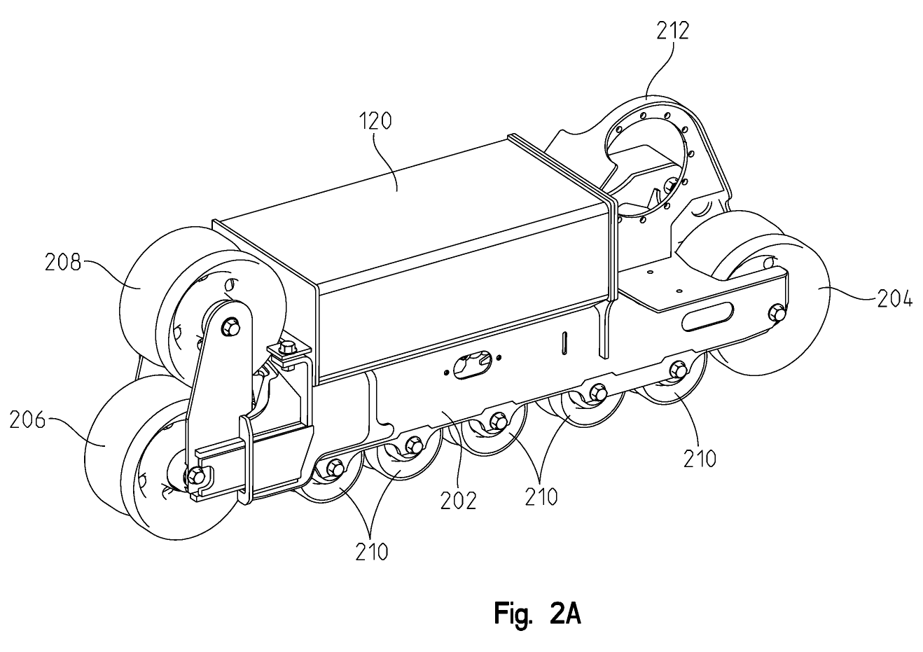

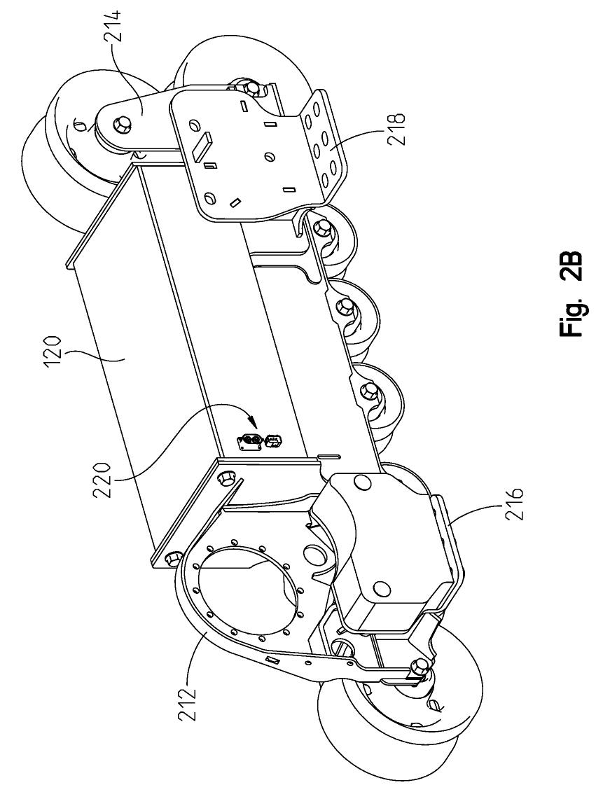

With further reference to FIGS. 2A and 2B, each track assembly 110 includes a track frame 202, a plurality of track wheels 114, 204, 206, 208, and a track loop 112 extending around the plurality of track wheels 114, 204, 206, and 208. In some implementations, the track wheel 114 is a drive wheel that is mounted to the drive motor 116 and the track wheels 204, 206, and 208 are idler track wheels. The track or undercarriage frame 202 is also supported on multiple track rollers 210. As shown in FIG. 2A, the track frame includes a longitudinal member supporting a pair of idler track wheels 206 and 208 at a forward end portion and an idler track wheel 204 at a rearward end portion. The battery pack 120 is positioned on a top side of the track frame 202 between the forward end portion and the rearward end portion.

As perhaps best shown in FIG. 2B, the track frame 202 includes a flange 212 to mount the drive motor 116 and one or more brackets, such as idler bracket 214, to mount the three idler track wheels 204, 206, and 208. In some implementations, one or more of the three idler track wheels 204, 206, and 208 can be mounted to the main frame 102. The battery pack 120 can include connectors 220 to connect the battery to the CTL 100 such that the battery pack 120 is in electrical communication with the drive motor 116 of the CTL 100. The track frame 202 also includes brackets 216 and 218 for mounting the track assembly 110 to the main frame 102 (FIG. 1).

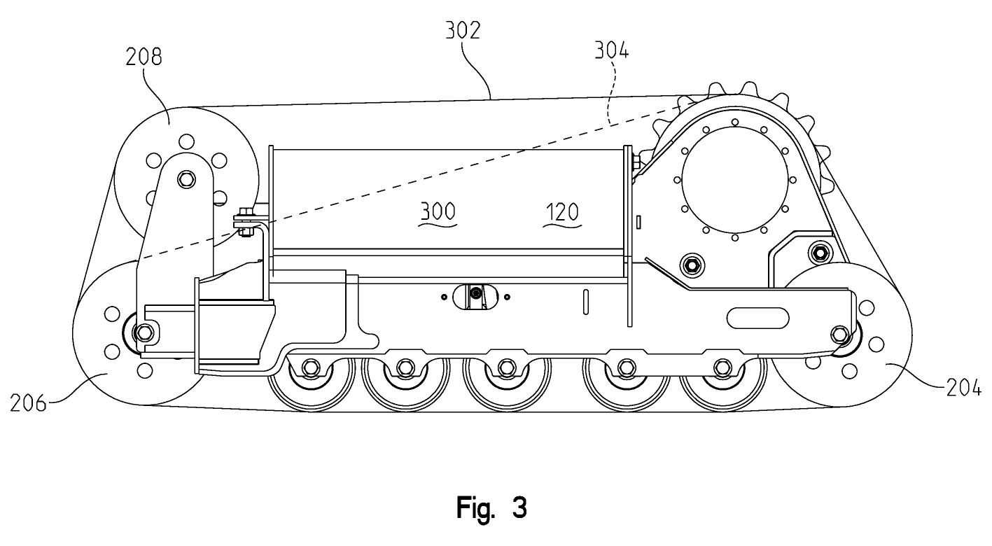

As shown in FIG. 3, the idler track wheels 204, 206, and 208 along with drive track wheel 114 (FIG. 1) support the track loop 112 in a quadrilateral configuration 302. This track configuration provides an envelope 300 for the battery pack 120 that is significantly larger than a conventional triangular track configuration 304. The envelope 300 is the space above the track frame 202 between the track frame 202 and the track loop 112. A CTL track loop is conventionally supported in a triangular configuration 304 around a rear idler track wheel (e.g., idler track wheel 204), a single forward idler track wheel (e.g., idler track wheel 206), and the drive wheel 114, as shown in FIG. 3.

In some implementations, the quadrilateral configuration 302 is in the form of a trapezoid as shown in FIG. 3. In other implementations, the quadrilateral configuration 302 can be in form of a parallelogram. Although the quadrilateral configuration 302 provides approximately twice as much space for the battery pack 120, in some implementations, a battery pack can be positioned in the envelope provided by the triangular configuration 304.

In other implementations, the track assembly 110 can have other track wheels configurations. For example, in one implementation the two forward idler wheels 206 and 208 can be replaced with one large idler wheel having a diameter corresponding to the combination of idler wheels 206 and 208. In another example, additional idler and/or drive wheels can be included. Furthermore, the idler track wheels and drive track wheel(s) can support the track loop in any suitable shape configuration to provide an envelope for the battery pack. It should also be appreciated that in some implementations, one or more battery packs can be mounted in the main frame 102 in addition to mounting battery packs on the track frames 202.

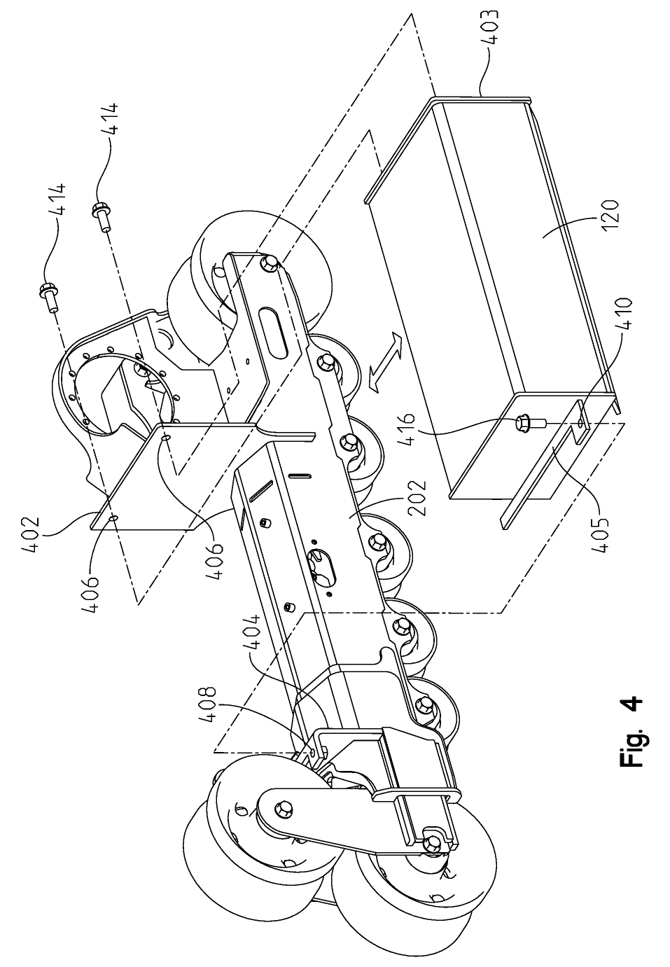

As shown in FIG. 4, the battery pack 120 can include a container 403 that encases one or more batteries (not visible). The batteries can be any suitable battery including lithium-ion, lead-acid, nickel-metal hydride, lithium iron phosphate, and solid-state batteries, for example. In some implementations, the container 403 can be constructed from steel sheet metal, for example. The container 403 can have various brackets, such as bracket 405, that are welded or otherwise fastened to the container 403. The container 403 protects the batteries and facilitates mounting the battery pack 120 to the track frame 202.

Accordingly, the track frame 202 can include brackets 402 and 408 positioned on the track frame 202 to mate with the battery pack container 403. For example, battery pack mounting bracket 404 is attached to a forward end portion of the track frame 202. The bracket 404 can be an angled bracket that includes a mounting hole 408 formed in a horizontal tab and positioned to correspond with a mounting hole 410 formed in bracket 405 of the battery pack 120. In some implementations, the mounting hole 408 is a threaded hole configured to receive a screw 416.

The battery pack mounting bracket 408 can be a vertically oriented plate that is welded or otherwise secured to a rearward end portion of the track frame 202. The bracket 408 can include mounting holes 406 corresponding to mounting holes formed in the battery pack container 403. The battery pack 120 can be fastened to the bracket 408 with screws 414 that extend through bracket mounting holes 406 and into the end plate of container 403.

It can be appreciated from the figures that the battery pack 120 is removable from the track assembly 110 while the track assembly 110 is attached to the main frame 102. In some implementations, the battery pack 120 is removable from the CTL 100 without removing any other components. For example, the battery pack 120 can be removed by removing fasteners 414 and 416 and disconnecting the connectors 220 (FIG. 2B) and sliding the battery pack 120 out of the track assembly 110 without removing the track loop 112 (FIG. 1).

Thus, the track assembly with battery pack disclosed herein provides for battery pack mounting that is much easier to install, access, maintain, and/or replace than those batteries that are conventionally mounted within a main frame of the vehicle. Frame mounted batteries can be difficult to access and require that much if not all of the vehicle’s undercarriage be removed to access the batteries.

While exemplary implementations incorporating the principles of the present disclosure have been described herein, the present disclosure is not limited to such implementations. Instead, this application is intended to cover any variations, uses, or adaptations of the disclosure using its general principles. Further, this application is intended to cover such departures from the present disclosure as come within known or customary practice in the art to which this disclosure pertains.

What is claimed is:

1. A vehicle, comprising:
a main frame;
a track assembly disposed on each lateral side of the main frame, each track assembly comprising:
a track frame;
a plurality of track wheels; and
a track loop extending around the plurality of track wheels; and
a battery pack mounted to the track frame.

2. The vehicle of claim 1, wherein the vehicle includes four track wheels supporting the track loop in a quadrilateral configuration.

3. The vehicle of claim 2, wherein three of the four track wheels are idler track wheels carried by the track frame and one of the four track wheels is a drive wheel.

4. The vehicle of claim 2, wherein the quadrilateral configuration is a trapezoidal configuration.

5. The vehicle of claim 2, wherein the battery pack is positioned on a top side of the track frame.

6. The vehicle of claim 1, further comprising a battery pack mounted to the main frame.

7. The vehicle of claim 1, wherein the battery pack is in electrical communication with a drive motor of the vehicle.

8. The vehicle of claim 1, wherein the battery pack is removable from the track assembly while the track assembly is attached to the main frame.

9. The vehicle of claim 1, wherein the track frame includes a longitudinal member supporting an idler track wheel at a forward end portion and an idler track wheel at a rearward end portion.

10. The vehicle of claim 9, wherein the battery pack is positioned on a top side of the track frame between the forward end portion and the rearward end portion.

11. The vehicle of claim 9, wherein the vehicle includes three track wheels supporting the track loop in a triangular configuration.

12. The vehicle of claim 9, wherein a pair of idler track wheels are supported at the forward end portion.

13. A track assembly for a vehicle, the track assembly comprising:
a track frame mountable on the vehicle;
at least one idler track wheel;
a track loop extending around the at least one track wheel and engageable with a drive wheel of the vehicle; and
a battery pack mounted to the track frame.

14. The track assembly of claim 13, including three idler track wheels positioned on the track frame to support the track loop, in conjunction with the drive wheel, in a quadrilateral configuration.

15. The track assembly of claim 14, wherein the quadrilateral configuration is a trapezoidal configuration.

16. The track assembly of claim 13, wherein the battery pack is positioned on a top side of the track frame.

17. The track assembly of claim 13, wherein the battery pack is electrically connectable to a drive motor of the vehicle.

18. The track assembly of claim 13, wherein the battery pack is removable from the track assembly while the track assembly is attached to the vehicle.

19. The track assembly of claim 13, wherein the track frame includes a longitudinal member supporting an idler track wheel at a forward end portion and an idler track wheel at a rearward end portion.

20. The track assembly of claim 19, wherein a pair of idler track wheels are supported at the forward end portion.
